(19) United States
(12) Patent Application Publication
(10) Pub. No.: US 2025/0331465 A1
(43) Pub. Date: Oct. 30, 2025

(54) BALE WRAP FEEDING ASSEMBLY FOR AN AGRICULTURAL HARVESTER

(71) Applicant: CNH Industrial America LLC, New Holland, PA (US)

(72) Inventors: Francisco Rivera, Leola, PA (US); Daniel Dallman, Eldridge, IA (US); Shane Peot, Appleton, WI (US); Scott Simmons, Lititz, PA (US)

(21) Appl. No.: 19/194,362

(22) Filed: Apr. 30, 2025

Related U.S. Application Data
(60) Provisional application No. 63/640,299, filed on Apr. 30, 2024.

(51) Int. Cl. A01F 15/07

(52) U.S. Cl. CPC A01F 15/071; A01F 2015/0725

(57) ABSTRACT

A bale wrap feeding assembly for an agricultural harvester includes a frame configured to move with respect to a lateral axis of the agricultural harvester from a feeding position to a loading position. In addition, the bale wrap feeding assembly includes a fixed feed roller rotatably and non-movably coupled to the frame, and the bale wrap feeding assembly includes a movable feed roller rotatably and movably coupled to the frame. The movable feed roller is movable between an engaged position and a disengaged position relative to the fixed feed roller, the movable feed roller is configured to be positioned proximate to the fixed feed roller while in the engaged position, and the movable feed roller is configured to be positioned remote from the fixed feed roller while in the disengaged position.

### CROSS-REFERENCE TO RELATED APPLICATION

This application claims priority from and the benefit of U.S. Provisional Application Ser. No. 63/640,299, entitled “BALE WRAP FEEDING ASSEMBLY FOR AN AGRICULTURAL HARVESTER”, filed Apr. 30, 2024, which is hereby incorporated by reference in its entirety.

### BACKGROUND

The present disclosure relates generally to a bale wrap feeding assembly for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale wrap feeding assembly for an agricultural harvester includes a frame configured to move with respect to a lateral axis of the agricultural harvester from a feeding position to a loading position. In addition, the bale wrap feeding assembly includes a fixed feed roller rotatably and non-movably coupled to the frame, and the bale wrap feeding assembly includes a movable feed roller rotatably and movably coupled to the frame. The movable feed roller is movable between an engaged position and a disengaged position relative to the fixed feed roller, the movable feed roller is configured to be positioned proximate to the fixed feed roller while in the engaged position to facilitate feeding a bale wrap between the movable feed roller and the fixed feed roller, and the movable feed roller is configured to be positioned remote from the fixed feed roller while in the disengaged position to facilitate loading the bale wrap between the movable feed roller and the fixed feed roller. The bale wrap feeding assembly also includes a fixed feed roller gear non-rotatably coupled to the fixed feed roller. Furthermore, the bale wrap feeding assembly includes a movable feed roller gear non-rotatably coupled to the movable feed roller. The movable feed roller gear is configured to engage the fixed feed roller gear while the movable feed roller is in the engaged position to enable rotation of the fixed feed roller to drive rotation of the movable feed roller.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a perspective view of an embodiment of a bale wrap feeding assembly that may be employed within the agricultural machine system of FIG. 1, in which a frame of the bale wrap feeding assembly is in a feeding position;

FIG. 4 is a perspective view of the bale wrap feeding assembly of FIG. 3, in which the frame is in a loading position;

FIG. 5 is a cross-sectional view of a portion of the bale wrap feeding assembly of FIG. 3;

FIG. 6 is a perspective view of a portion of the bale wrap feeding assembly of FIG. 3;

FIG. 7 is a perspective view of another portion of the bale wrap feeding assembly of FIG. 3; and

FIG. 8 is a perspective view of a further portion of the bale wrap feeding assembly of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

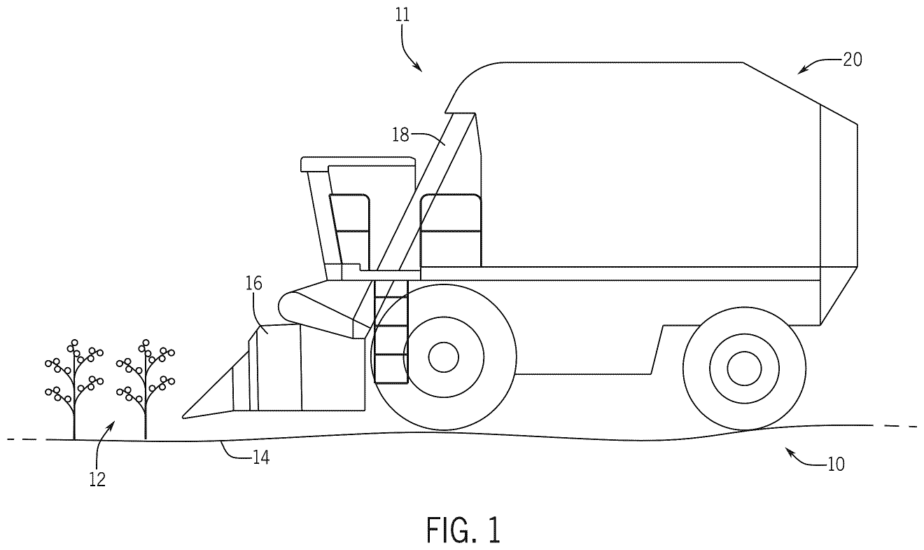

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

As discussed in detail below, the agricultural machine system 10 includes a bale wrap feeding assembly configured to feed the bale wrap toward the bale. The bale wrap feeding assembly includes a frame configured to move with respect to a lateral axis of the agricultural machine system 10 from a feeding position to a loading position. The bale wrap feeding assembly also includes a fixed feed roller rotatably and non-movably coupled to the frame. In addition, the bale wrap feeding assembly includes a movable feed roller rotatably and movably coupled to the frame. The movable feed roller is movable between an engaged position and a disengaged position relative to the fixed feed roller. The movable feed roller is configured to be positioned proximate to the feed roller while in the engaged position to facilitate feeding the bale wrap between the movable feed roller and the fixed feed roller, and the movable feed roller is configured to be positioned remote from the fixed feed roller while in the disengaged position to facilitate loading the bale wrap between the movable feed roller and the fixed feed roller. Furthermore, the bale wrap feeding assembly includes a fixed feed roller gear non-rotatably coupled to the fixed feed roller, and the bale wrap feeding assembly includes a movable feed roller gear non-rotatably coupled to the movable feed roller. The movable feed roller gear is configured to engage the fixed feed roller gear while the movable feed roller is in the engaged position to enable rotation of the fixed feed roller to drive rotation of the movable feed roller.

To load the bale wrap into the bale wrap feeding assembly, the frame is moved from the feeding position to the loading position, and the movable feed roller is moved from the engaged position to the disengaged position. The bale wrap is then loaded between the movable feed roller and the fixed feed roller, and the movable feed roller is moved from the disengaged position to the engaged position. Because the frame is in the loading position, an operator may access the entire lateral extent of the feed rollers, thereby facilitating efficient loading of the bale wrap between the feed rollers. In addition, the ability to move the frame to the loading position enhances access to multiple components of the bale wrap feeding assembly, thereby facilitating maintenance and repair operations. Furthermore, because the movable feed roller is driven by a geared connection to the fixed feed roller, the movable feed roller and the fixed feed roller may be driven by a common drive while enabling the movable feed roller to move between the engaged and disengaged positions.

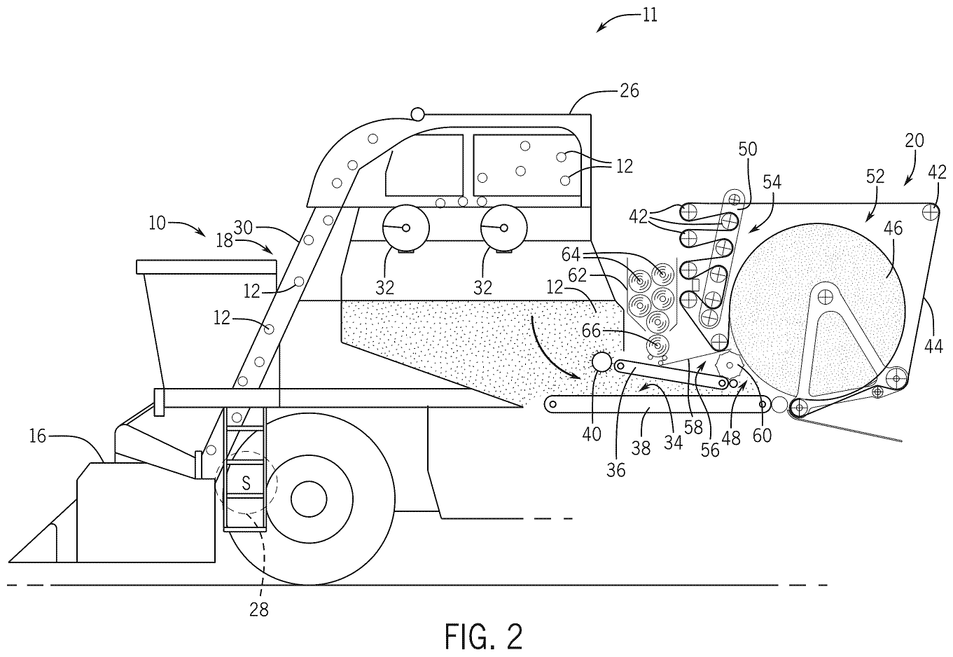

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to the accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 configured to distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a first belt (e.g., belt) 36 configured to move the agricultural product 12 from the accumulator assembly 26 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator assembly 26 to the baler 20. Furthermore, in the illustrated embodiment, the conveying system 34 includes an agitation roller 40 positioned upstream of the first belt 36. The agitation roller 40 is configured to agitate the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more feed rollers. The feed rollers drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator assembly 26 to the baler 20 and to form the bale 46. For example, as the agricultural machine system 10 traverses a field, the agricultural product 12 may accumulate within the accumulator assembly 26. After a selected duration, the conveying system 34 may be activated to transfer the agricultural product 12 from the accumulator assembly 26 to the baler 20. For example, the conveying system 34 may move the agricultural product 12 toward the baler 20 at a significantly faster rate than the air-assisted conveying system 18 moves the agricultural product 12 into the accumulator assembly 26. Concurrently with activation of the conveying system 34, the baler 20 may be activated to initiate the bale forming process, as described above. After another selected duration, the conveying system 34 and the baler 20 may be deactivated to enable the accumulator assembly 26 to collect additional agricultural product 12. In certain embodiments, the conveying assembly 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, as discussed in detail below, the agricultural machine system 10 (e.g., the bale wrapping system 56 of the agricultural machine system 10) includes a bale wrap feeding assembly configured to receive an active bale wrap assembly 66 from the bale wrap assembly storage compartment 62 and to feed the bale wrap 58 of the active bale wrap assembly 66 toward the bale 46 (e.g., toward the starter roller 60). The bale wrap feeding assembly includes a frame configured to move with respect to a lateral axis of the agricultural machine system 10 from a feeding position to a loading position, and the bale wrap feeding assembly is configured to receive the active bale wrap assembly 66 while the frame is in the feeding position. In addition, the bale wrap feeding assembly includes a fixed feed roller rotatably and non-movably coupled to the frame, and the bale wrap feeding assembly includes a movable feed roller rotatably and movably coupled to the frame. The movable feed roller is movable between an engaged position and a disengaged position relative to the fixed feed roller. The movable feed roller is configured to be positioned proximate to the fixed feed roller while in the engaged position to facilitate feeding the bale wrap 58 of the active bale wrap assembly 66 between the movable feed roller and the fixed feed roller, and the movable feed roller is configured to be positioned remote from the fixed feed roller while in the disengaged position to facilitate loading the bale wrap 58 of the active bale wrap assembly 66 between the movable feed roller and the fixed feed roller. Furthermore, the bale wrap feeding assembly includes a fixed feed roller gear non-rotatably coupled to the fixed feed roller, and the bale wrap feeding assembly includes a movable feed roller gear non-rotatably coupled to the movable feed roller. The movable feed roller gear is configured to engage the fixed feed roller gear while the movable feed roller is in the engaged position to enable rotation of the fixed feed roller to drive rotation of the movable feed roller.

To load the bale wrap of the active bale wrap assembly 66 into the bale wrap feeding assembly, the frame is moved from the feeding position to the loading position, and the movable feed roller is moved from the engaged position to the disengaged position. The bale wrap is then loaded between the movable feed roller and the fixed feed roller, and the movable feed roller is moved from the disengaged position to the engaged position. Because the frame is in the loading position, an operator may access the entire lateral extent of the feed rollers, thereby facilitating efficient loading of the bale wrap between the feed rollers. In addition, the ability to move the frame to the loading position enhances access to multiple components of the bale wrap feeding assembly, thereby facilitating maintenance and repair operations (e.g., including repairing the active bale wrap assembly, reloading the bale wrap between the fixed feed roller and the movable feed roller, removing the active bale wrap assembly, cleaning components of the bale wrap feeding assembly, etc.). Furthermore, because the movable feed roller is driven by a geared connection to the fixed feed roller, the movable feed roller and the fixed feed roller may be driven by a common drive while enabling the movable feed roller to move between the engaged and disengaged positions.

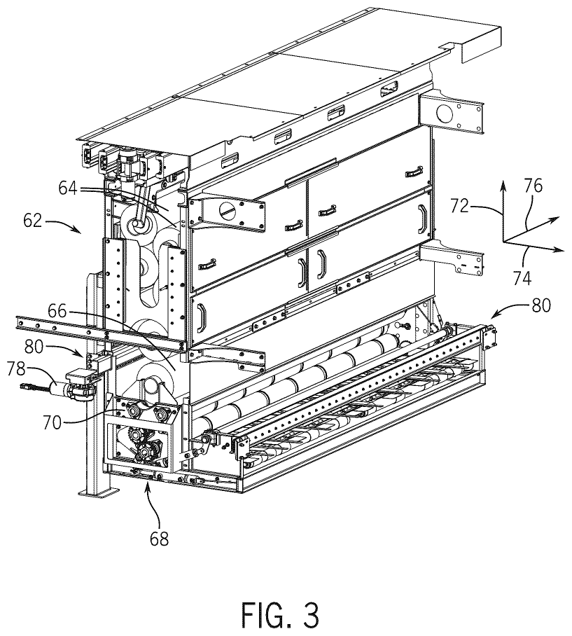

FIG. 3 is a perspective view of an embodiment of a bale wrap feeding assembly 68 that may be employed within the agricultural machine system of FIG. 1, in which a frame 70 of the bale wrap feeding assembly 68 is in a feeding position. As previously discussed, the bale wrap assembly storage compartment 62 is configured to store multiple bale wrap assemblies 64. In addition, the bale wrap assembly storage compartment 62 is configured to feed the active bale wrap assembly 66 downwardly with respect to a vertical axis 72 of the agricultural machine system to the bale wrap feeding assembly 68. The bale wrap feeding assembly 68 is configured to receive the active bale wrap assembly 66 from the bale wrap assembly storage compartment 62 while the frame 70 is in the illustrated feeding position. In addition, while the frame 70 is in the illustrated feeding position, the bale wrap feeding assembly 68 is configured to feed the bale wrap of the active bale wrap assembly 66 toward the bale with respect to a longitudinal axis 74 of the agricultural machine system. While the bale wrap feeding assembly 68 is configured to receive the active bale wrap assembly 66 from the bale wrap assembly storage compartment 62 in the illustrated embodiment, in other embodiments, the bale wrap assembly storage compartment may be omitted. In such embodiments, the bale wrap feeding assembly may receive the active bale wrap while the frame is in the loading position.

As previously discussed, the frame 70 is configured to move with respect to a lateral axis 76 between the illustrated feeding position and the loading position. As discussed in detail below, with the frame 70 in the loading position, the bale wrap of the active bale wrap assembly 66 may be loaded through the feed rollers of the bale wrap feeding assembly 68. In the illustrated embodiment, the bale wrap feeding assembly 68 includes a motor 78 (e.g., frame drive motor) configured to drive the frame 70 to move between the illustrated feeding position and the loading position. The motor 78 may include an electric motor, a pneumatic motor, a hydraulic motor, another suitable type of motor, or a combination thereof. In certain embodiments, a track is coupled to the frame, a gear is coupled to a shaft of the motor, and the gear is engaged with the track. The motor is configured to drive the gear to rotate, thereby driving the frame to move with respect to the lateral axis. However, in other embodiments, another suitable mechanism (e.g., screw drive, etc.) may enable the motor to drive the frame to move with respect to the lateral axis. Furthermore, in certain embodiments, the bale wrap feeding assembly may include another suitable actuator (e.g., electric linear actuator, hydraulic cylinder, pneumatic cylinder, etc.) configured to drive the frame to move with respect to the lateral axis. In addition, in certain embodiments, the bale wrap feeding assembly may not include any device (e.g., motor, actuator, etc.) configured to drive the frame to move between the feeding and loading positions. In such embodiments, an operator may manually move the frame with respect to the lateral axis between the feeding and loading positions.

In the illustrated embodiment, the bale wrap feeding assembly 68 includes track assemblies 80 configured to guide the frame 70 to move with respect to the lateral axis 76 between the feeding position and the loading position. In the illustrated embodiment, the bale wrap feeding assembly 68 includes two track assemblies 80 positioned on opposite longitudinal sides of the frame 70. However, in other embodiments, the bale wrap feeding assembly may include more or fewer track assemblies (e.g., 1, 3, 4, or more), and each track assembly may be positioned at any suitable location on the frame. In addition, while the bale wrap feeding assembly 68 includes track assemblies 80 in the illustrated embodiment, in other embodiments, the bale wrap feeding assembly may include any other suitable assemblies (e.g., alone or in combination with the track assembly/assemblies) to guide movement of the frame with respect to the lateral axis, such as one or more slot and groove assemblies, one or more protrusion and recess assemblies, etc.

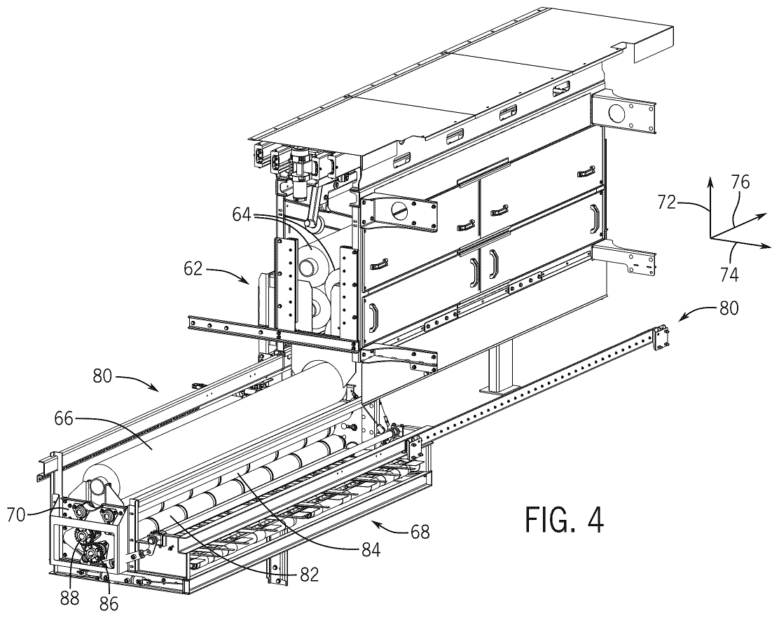

FIG. 4 is a perspective view of the bale wrap feeding assembly 68 of FIG. 3, in which the frame 70 is in a loading position. As previously discussed, the bale wrap feeding assembly 68 includes a fixed feed roller 82 rotatably and non-movably coupled to the frame 70, and the bale wrap feeding assembly 68 includes a movable feed roller 84 rotatably and movably coupled to the frame 70. In addition, the movable feed roller 84 is movable between the illustrated engaged position and a disengaged position relative to the fixed feed roller 82. The movable feed roller 84 is configured to be positioned proximate to the fixed feed roller 82 while in the engaged position to facilitate feeding the bale wrap of the active bale wrap assembly 66 between the movable feed roller 84 and the fixed feed roller 82. Furthermore, the movable feed roller 84 is configured to be positioned remote from the fixed feed roller 82 while in the disengaged position to facilitate loading the bale wrap of the active bale wrap assembly 66 between the movable feed roller 84 and the fixed feed roller 82. The bale wrap feeding assembly 68 also includes a fixed feed roller gear 86 non-rotatably coupled to the fixed feed roller 82. In addition, the bale wrap feeding assembly 68 includes a movable feed roller gear 88 non-rotatably coupled to the movable feed roller 84. The movable feed roller gear 88 is configured to engage the fixed feed roller gear 86 while the movable feed roller 84 is in the illustrated engaged position to enable rotation of the fixed feed roller 82 to drive rotation of the movable feed roller 84.

With the frame 70 in the illustrated loading position, the bale wrap of the active bale wrap assembly 66 may be loaded into the bale wrap feeding assembly 68. To facilitate the bale wrap loading process, the movable feed roller 84 is moved from the illustrated engaged position to the disengaged position. The bale wrap of the active bale wrap assembly 66 is then loaded between the movable feed roller 84 and the fixed feed roller 82. With the frame 70 in the illustrated loading position, an operator may access the entire lateral extent of the feed rollers, thereby facilitating efficient loading of the bale wrap between the feed rollers. In addition, the ability to move the frame 70 to the illustrated loading position enhances access to multiple components of the bale wrap feeding assembly, thereby facilitating maintenance and repair operations. Furthermore, in certain embodiments, the bale wrap feeding assembly 68 may receive the active bale wrap assembly 66 while the frame is in the illustrated loading position (e.g., in situations in which a type of bale wrap not present in the bale wrap assembly storage compartment is desired, in situations in which the bale wrap assembly storage compartment is empty, in embodiments in which the agricultural machine system does not include the bale wrap assembly storage compartment, etc.)

After the bale wrap is loaded between the feed rollers, the movable feed roller 84 may be moved from the disengaged position to the illustrated engaged position. As a result, the movable feed roller gear 88 engages the fixed feed roller gear 86, thereby enabling rotation of the fixed feed roller 82 to drive rotation of the movable feed roller 84. The frame 70 may then be moved with respect to the lateral axis 76 from the illustrated loading position to the feeding position. For example, the motor disclosed above may drive the frame to move from the illustrated loading position to the feeding position. With the frame in the feeding position, the bale wrap feeding assembly 68 may feed the bale wrap of the active bale wrap assembly 66 toward the bale.

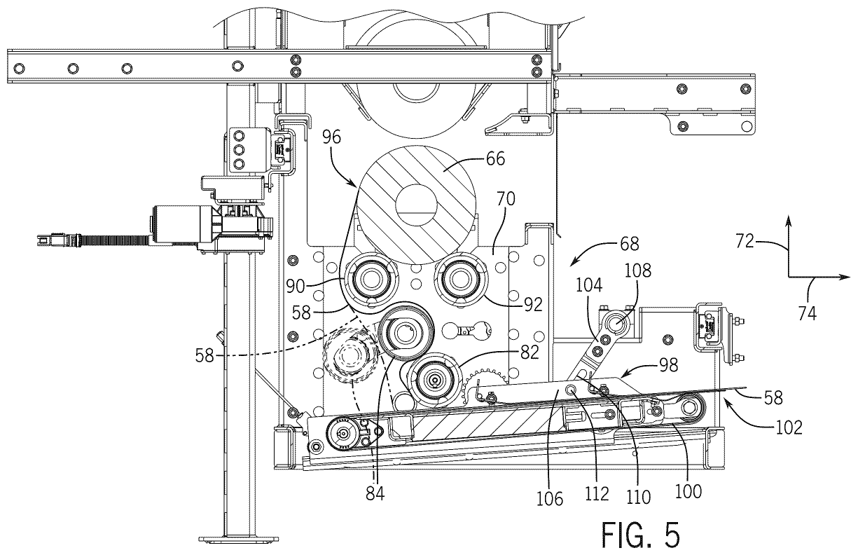

FIG. 5 is a cross-sectional view of a portion of the bale wrap feeding assembly 68 of FIG. 3. In the illustrated embodiment, the bale wrap feeding assembly 68 includes a first support roller 90 and a second support roller 92. Each support roller is rotatably and non-movably coupled to the frame 70, and the first and second support rollers are configured to support the active bale wrap assembly 66 within the bale wrap feeding assembly 68. Accordingly, the bale wrap loading process includes receiving the active bale wrap assembly 66 onto the first support roller 90 and the second support roller 92. The frame 70 is then moved with respect to the lateral axis from the feeding position to the loading position. Next, the first support roller 90 and the second support roller 92 are rotated (e.g., by a motor) to drive the active bale wrap assembly 66 to rotate, such that an end (e.g., leading end) of the bale wrap 58 of the active bale wrap assembly 66 is positioned at a target location 96. In certain embodiments, the end of the bale wrap is coupled to another portion of the bale wrap (e.g., via tape, via adhesive, etc.) to facilitate transport and storage of the bale wrap assembly. Accordingly, positioning the end of the bale wrap at the target location 96 enables an operator to disconnect the connection(s) between the end of the bale wrap and the other portion of the bale wrap, thereby enabling the bale wrap to be loaded into the bale wrap feeding assembly 68.

After the movable feed roller 84 is moved to the disengaged position, shown in dashed lines, the operator routes the bale wrap 58 around the first support roller 90, such that the bale wrap 58 is positioned laterally outwardly from the support rollers. The bale wrap 58 may then be loaded between the movable feed roller 84 and the fixed feed roller 82, such that the bale wrap 58, shown as a dashed line, is positioned between the movable feed roller 84 and the fixed feed roller 82 with respect to the longitudinal axis 74. Next, the movable feed roller 84 is moved to the engaged position, shown in solid lines, thereby capturing the bale wrap 58, shown as a solid line, between the movable feed roller 84 and the fixed feed roller 82. As previously discussed, moving the movable feed roller 84 to the engaged position causes the movable feed roller gear to engage the fixed feed roller gear, thereby enabling rotation of the fixed feed roller 82 to drive rotation of the movable feed roller 84.

In the illustrated embodiment, the bale wrap feeding assembly 68 includes a belt assembly 98 configured to receive the bale wrap 58 from the fixed feed roller 82 and the movable feed roller 84. In addition, the belt assembly 98 is configured to drive the bale wrap 58 to move toward the bale. Accordingly, during the bale wrap loading process, the bale wrap 58 is loaded between the fixed feed roller 82 and belts 100 of the belt assembly 98. The frame 70 is then moved from the loading position to the feeding position.

In the illustrated embodiment, the belt assembly 98 is movable from the illustrated retracted position to an extended position. Positioning the belt assembly 98 in the retracted position facilitates movement of the frame 70 between the loading position and the feeding position (e.g., by providing clearance between the belt assembly 98 and other components of the agricultural machine system). In addition, positioning the belt assembly in the extended position locates a longitudinal end 102 of the belt assembly 98 closer to the starter roller while the frame is in the feeding position, thereby facilitating feeding the bale wrap 58 from the belt assembly 98 to the starter roller. In the illustrated embodiment, the bale wrap feeding assembly 68 includes arm(s) 104 pivotally coupled to a chassis 106 of the belt assembly 98 and non-pivotally coupled to a rockshaft 108. The rockshaft 108 is pivotally coupled to the frame 70, and the rockshaft 108 is driven to rotate by an actuator, as discussed in detail below. Furthermore, track assemblies are coupled to the belt assembly chassis 106 and to the frame 70. The track assemblies are configured to guide the belt assembly 98 to move between the illustrated retracted position and the extended position. In addition, each arm 104 includes a slot 110, and a fastener 112 extends through the slot 110, thereby pivotally coupling the arm 104 to the chassis 106. As each arm 104 is driven to rotate by the rockshaft 108, contact between the arm 104 and the respective fastener 112 drives the belt assembly 98 to move between the illustrated retracted position and the extended position. While track assemblies are disclosed above, in certain embodiments, other suitable assemblies (e.g., alone or in combination with the track assemblies) may guide movement of the belt assembly, such as one or more slot and groove assemblies, one or more protrusion and recess assemblies, etc. Furthermore, while the belt assembly 98 is driven to move by the rockshaft 108 and arm(s) 104 in the illustrated embodiment, in other embodiments, the belt assembly may be driven to move by another suitable assembly, such as a screw drive, a gear and track assembly, a linear actuator (e.g., hydraulic cylinder, etc.), etc. While the belt assembly 98 is movable in the illustrated embodiment, in other embodiments, the belt assembly may be fixed with respect to the frame of the bale wrap feeding assembly.

After the bale wrap 58 is loaded between the fixed feed roller 82 and the belts 100 of the belt assembly 98, the frame 70 is moved from the loading position to the feeding position. The belt assembly 98 is then moved to the extended position, such that the longitudinal end 102 of the belt assembly 98 is positioned closer to the starter roller. To wrap a bale with the bale wrap 58 of the active bale wrap assembly 66, the first support roller 90, the second support roller 92, the movable feed roller 84, the fixed feed roller 82, and the belts 100 are driven to rotate, thereby feeding the bale wrap 58 to the starter roller.

While the bale wrap feeding assembly includes two support rollers in the illustrated embodiment, in other embodiments, the bale wrap feeding assembly may include more or fewer support rollers (e.g., 0, 1, 3, 4, or more). For example, in certain embodiments, the support rollers may be omitted, and the bale wrap feeding assembly may include other suitable device(s) to support the active bale wrap assembly (e.g., cradle, support rod(s), support bushing(s), etc.). Furthermore, while the bale wrap feeding assembly includes the belt assembly in the illustrated embodiment, in other embodiments, the belt assembly may be omitted. In such embodiments, the bale wrap feeding assembly may include additional feed rollers to drive the bale wrap toward the bale. Furthermore, while the bale wrap feeding assembly includes a single fixed feed roller in the illustrated embodiment, in other embodiments, the bale wrap feeding assembly may include multiple fixed feed rollers (e.g., 2, 3, 4, 5, 6, or more).

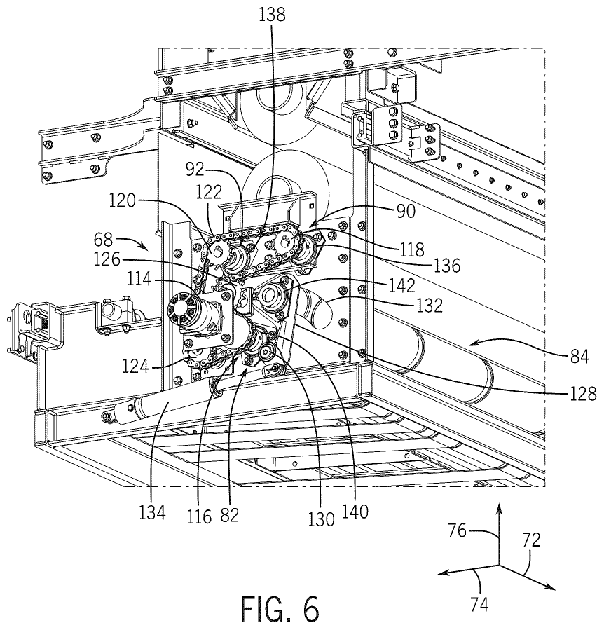

FIG. 6 is a perspective view of a portion of the bale wrap feeding assembly 68 of FIG. 3. In the illustrated embodiment, the bale wrap feeding assembly 68 includes a motor 114 (e.g., roller drive motor) configured to drive the first support roller 90, the second support roller 92, the fixed feed roller 82, and the belts of the belt assembly to rotate. The motor 114 may include an electric motor, a hydraulic motor, a pneumatic motor, another suitable type of motor, or a combination thereof. Furthermore, as previously discussed, with the movable feed roller 84 in the illustrated engaged position, the movable feed roller gear engages the fixed feed roller gear, such that rotation of the fixed feed roller 82 drives rotation of the movable feed roller 84. Accordingly, the first support roller 90, the second support roller 92, the movable feed roller 84, the fixed feed roller 82, and the belts are driven to rotate by a single motor 114. As a result, the cost and complexity of the bale wrap feeding assembly 68 may be reduced (e.g., as compared to a bale wrap feeding assembly having multiple motors).

In the illustrated embodiment, a fixed feed roller drive gear 116 is non-rotatably coupled to the fixed feed roller 82, a first support roller drive gear 118 is non-rotatably coupled to the first support roller 90, and a second support roller drive gear 120 is non-rotatably coupled to the second support roller 92. In addition, the fixed feed roller drive gear 116, the first support roller drive gear 118, and the second support roller drive gear 120 engage a chain 122 (e.g., roller drive chain). In the illustrated embodiment, a shaft of the motor 114 is non-rotatably coupled to the fixed feed roller drive gear 116. Accordingly, rotation of the shaft of the motor 114 drives the fixed feed roller gear 116 to rotate, which drives the first and second support roller drive gears to rotate via the chain 112. As such, the first support roller 90, the second support roller 92, and the fixed feed roller 82 are driven to rotate by the motor 114. While the shaft of the motor 114 is non-rotatably coupled to the fixed feed roller drive gear 116 in the illustrated embodiment, in other embodiments, the shaft of the motor may be coupled to any other suitable gear, or the shaft of the motor may be coupled to an additional gear that is non-rotatably coupled to the shaft of the motor and engaged with the chain.

Furthermore, in the illustrated embodiment, the bale wrap feeding assembly 68 includes a belt driving gear 124 engaged with the chain 122. The belt driving gear 124 is rotatably and non-movably coupled to the frame 70. As discussed in detail below, the belt driving gear 124 is configured to drive the belts of the belt assembly to rotate. In addition, in the illustrated embodiment, the bale wrap feeding assembly 68 includes a tension adjustment gear 126 engaged with the chain 122. The tension adjustment gear 126 is rotatably and movably coupled to the frame 70. The position of the tension adjustment gear 126 may be adjusted to control the tension of the chain 122. While the bale wrap feeding assembly 68 includes gears and a chain 122 in the illustrated embodiment, in other embodiments, the bale wrap feeding assembly may include pullies (e.g., a first support roller drive pully, a second support roller drive pully, a tension adjustment pully, a fixed feed roller drive pully, and a belt driving pully) and a belt engaged with the pullies. Furthermore, in certain embodiments, at least one component may be driven to rotate by at least one other motor. For example, the first support roller and the second support roller may be driven to rotate by one motor, and the fixed feed roller and the belts may be driven to rotate by another motor. By way of further example, the belts may be driven to rotate by a first motor, the fixed feed roller may be driven to rotate by a second motor, and the first support roller and the second support roller may be driven to rotate by a third motor.

As previously discussed, the movable feed roller 84 is movable between the illustrated engaged position and the disengaged position relative to the fixed feed roller 82. In the illustrated embodiment, the movable feed roller 84 is rotatably and non-movably coupled to a first arm 128, and the first arm 128 is pivotally coupled to the frame 70 at a first pivot joint 130. In addition, as discussed in detail below, the movable feed roller 84 is also rotatably and non-movably coupled to a second arm, and the second arm is pivotally coupled to the frame at a second pivot joint. The first and second arms are positioned on opposite lateral sides of the frame. The arms and pivot joints enable the movable feed roller 84 to move relative to the frame 70. Accordingly, the movable feed roller 84 is rotatably and movably coupled to the frame 70. Furthermore, in the illustrated embodiment, the frame 70 has a first slot 132 and a second slot positioned on opposite lateral sides of the frame 70. The slots facilitate movement of the movable feed roller 84 between the illustrated engaged position and the disengaged position.

In the illustrated embodiment, the bale wrap feeding assembly 68 includes a first actuator 134 (e.g., first movable feed roller actuator) configured to drive the movable feed roller 84 to move between the illustrated engaged position and the disengaged position. The first actuator 134 is pivotally coupled to the frame 70 and to the first arm 128. In addition, as discussed in detail below, the bale wrap feeding assembly 68 includes a second actuator configured to drive the movable feed roller to move between the engaged and disengaged position, and the first and second actuators are positioned on opposite lateral sides of the frame. The first and second actuators are configured to drive the first and second arms to pivot about the respective pivot joints, thereby driving the movable feed roller to move between the engaged and disengaged positions. In the illustrated embodiment, the first actuator 134 includes a hydraulic cylinder. However, in other embodiments, the first actuator may include other suitable actuation device(s) (e.g., alone or in combination with the hydraulic cylinder), such as a pneumatic cylinder, an electric linear actuator, etc.

In the illustrated embodiment, the first support roller 90 is rotatably and non-movably coupled to the frame 70 by a respective first bearing assembly 136 and a respective second bearing assembly, and the second support roller 92 is rotatably and non-movably coupled to the frame 70 by a respective first bearing assembly 138 and a respective second bearing assembly. In addition, the fixed feed roller 82 is rotatably and non-movably coupled to the frame 70 by a respective first bearing assembly 140 and a respective second bearing assembly. Furthermore, the movable feed roller 84 is rotatably and non-movably coupled to the first arm 128 by a respective first bearing assembly 142, and the movable feed roller 84 is rotatably and non-movably coupled to the second arm by a respective second bearing assembly. The first bearing assemblies and the second bearing assemblies are positioned on opposite lateral sides of the frame, and each bearing assembly is configured to facilitate rotation of the respective roller. While each roller is rotatably supported by respective bearing assemblies in the illustrated embodiment, in other embodiments, at least one roller may be rotatably supported by other suitable connections, such as bushing assemblies, etc.

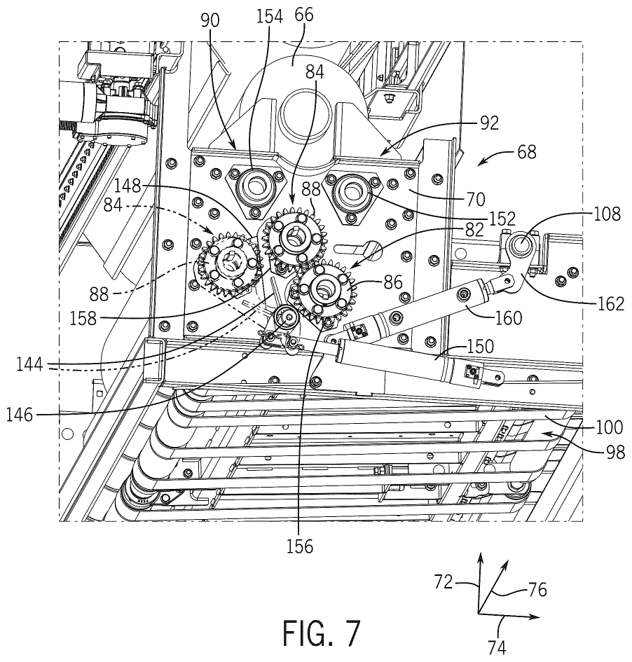

FIG. 7 is a perspective view of a portion of the bale wrap feeding assembly 68 of FIG. 3. As previously discussed, the movable feed roller 84 is rotatably and non-movably coupled to the second arm 144, and the second arm 144 is pivotally coupled to the frame 70 at the second pivot joint 146. The first and second arms and the first and second pivot joints enable the movable feed roller 84 to move between the engaged position, as shown in solid lines, and the disengaged position, as shown in dashed lines. Furthermore, in the illustrated embodiment, the frame 70 has the second slot 148, and the first and second slots facilitate movement of the movable feed roller 84 between the engaged position and the disengaged position. As previously discussed, the movable feed roller 84 is configured to be positioned proximate to the fixed feed roller 82 while in the engaged position to facilitate feeding the bale wrap between the movable feed roller 84 and the fixed feed roller 82, and the movable feed roller 84 is configured to be positioned remote from the fixed feed roller 82 while in the disengaged position to facilitate loading the bale wrap between the movable feed roller 84 and the fixed feed roller 82.

In the illustrated embodiment, the bale wrap feeding assembly 68 includes the second actuator 150 (e.g., second movable feed roller actuator) configured to drive the movable feed roller 84 to move between the engaged position and the disengaged position. The second actuator 148 is pivotally coupled to the frame 70 and to the second arm 144. As previously discussed, the first and second actuators are configured to drive the first and second arms to pivot about the respective pivot joints, thereby driving the movable feed roller to move between the engaged and disengaged positions. In the illustrated embodiment, the second actuator 150 includes a hydraulic cylinder. However, in other embodiments, the second actuator may include other suitable actuation device(s) (e.g., alone or in combination with the hydraulic cylinder), such as a pneumatic cylinder, an electric linear actuator, etc. While the bale wrap feeding assembly 68 includes two actuators for driving the movable feed roller 84 to move in the illustrated embodiment, in other embodiments, the bale wrap feeding assembly may include more or fewer actuators configured to drive the movable feed roller to move, such as 1, 3, 4, or more. Furthermore, in certain embodiments, one or more motors (e.g., alone or in combination with the actuator(s)) may drive the arms to rotate. In addition, in certain embodiments, the arms may be omitted, and one or more actuators may directly drive the movable feed roller to move between the engaged and disengaged positions.

In addition, as previously discussed, the bale wrap feeding assembly 68 includes the fixed feed roller gear 86 non-rotatably coupled to the fixed feed roller 82, and the bale wrap feeding assembly 68 includes the movable feed roller gear 88 non-rotatably coupled to the movable feed roller 84. The movable feed roller gear 88 is configured to engage the fixed feed roller gear 86 while the movable feed roller 84 is in the engaged position to enable rotation of the fixed feed roller 82 to drive rotation of the movable feed roller 84. In addition, the movable feed roller gear 88 is configured to disengage the fixed feed roller gear 86 while the movable feed roller 84 is in the disengaged position, such that the movable feed roller 84 is not driven to rotate while in the disengaged position. While gears are non-rotatably coupled to the movable and fixed feed rollers in the illustrated embodiment, in other embodiments, a fixed feed roller wheel may be non-rotatably coupled to the fixed feed roller, and a movable feed roller wheel may be non-rotatably coupled to the movable feed roller. In such embodiments, the movable feed roller wheel is configured to engage the fixed feed roller wheel while the movable feed roller is in the engaged position to enable rotation of the fixed feed roller to drive rotation of the movable feed roller.

As previously discussed, the first support roller 90 is rotatably and non-movably coupled to the frame 70 by the respective first bearing assembly and the respective second bearing assembly 152, and the second support roller 92 is rotatably and non-movably coupled to the frame 70 by the respective first bearing assembly and the respective second bearing assembly 154. In addition, the fixed feed roller 82 is rotatably and non-movably coupled to the frame 70 by the respective first bearing assembly and the respective second bearing assembly 156. Furthermore, the movable feed roller 84 is rotatably and non-movably coupled to the first arm by the respective first bearing assembly, and the movable feed roller 84 is rotatably and non-movably coupled to the second arm 144 by the respective second bearing assembly 158. As previously discussed, the first bearing assemblies and the second bearing assemblies are positioned on opposite lateral sides of the frame, and each bearing assembly is configured to facilitate rotation of the respective roller.

As previously discussed, the belt assembly 98 is movable from the illustrated retracted position to the extended position. Furthermore, as previously discussed, arm(s) are pivotally coupled to the chassis of the belt assembly 98 and non-pivotally coupled to the rockshaft 108, and the rockshaft 108 is pivotally coupled to the frame 70. In the illustrated embodiment, an actuator 160 (e.g., belt assembly actuator) is configured to drive the rockshaft 108 to rotate. The actuator 160 is pivotally coupled to the frame 70, and the actuator 160 is pivotally coupled to a crank arm 162 that is non-pivotally coupled to the rockshaft 108. Accordingly, the actuator 160 is configured to drive the crank arm 162 to pivot relative to the frame 70, thereby driving the crank shaft 108 to pivot relative to the frame 70. As previously discussed, rotation of the crankshaft 108 drives each arm to rotate, and as each arm rotates, contact between the arm and the respective fastener drives the belt assembly 98 to move between the illustrated retracted position and the extended position. Accordingly, the actuator 160 is configured to drive the belt assembly 98 to move between the retracted and extended positions. In the illustrated embodiment, the first actuator 160 includes a hydraulic cylinder. However, in other embodiments, the actuator may include other suitable actuation device(s) (e.g., alone or in combination with the hydraulic cylinder), such as a pneumatic cylinder, an electric linear actuator, etc. Furthermore, while the bale wrap feeding assembly 68 includes a single actuator 160 configured to drive the belt assembly 98 to move in the illustrated embodiment, in other embodiments, the bale wrap feeding assembly may include multiple actuators (e.g., 2, 3, 4, or more) configured to drive the belt assembly to move.

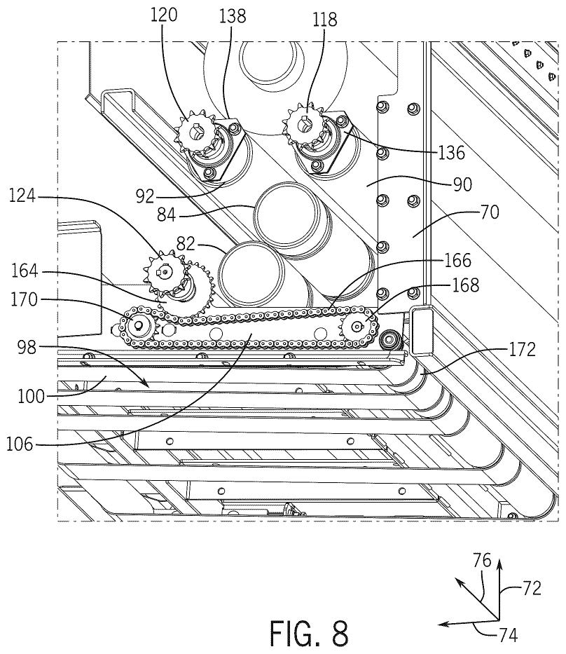

FIG. 8 is a perspective view of a portion of the bale wrap feeding assembly 68 of FIG. 3. As previously discussed, the belt driving gear 124 is configured to drive the belts 100 of the belt assembly 98 to rotate. In the illustrated embodiment, the belt driving gear 124 is non-rotatably coupled to a secondary belt driving gear 164, and the secondary belt driving gear 164 is rotatably and non-movably coupled to the frame 70. Furthermore, the secondary belt driving gear 164 is engaged with a belt driving chain 166. In the illustrated embodiment, the belt assembly 98 includes a drive gear 168 rotatably and non-movably coupled to the chassis 106, and the belt assembly 98 includes an idler gear 170 rotatably and non-movably coupled to the chassis 106. As illustrated, the belt driving chain 166 is engaged with the drive gear 168 and the idler gear 170, and the drive gear is non-rotatably coupled to a drive roller 172 of the belt assembly 98. Accordingly, as the roller drive chain drives the belt driving gear 124 to rotate, the belt driving gear 124 drives the second belt driving gear 164 to rotate, thereby driving the belt driving chain 166 to rotate. In addition, rotation of the belt driving chain 166 drives the idler gear 170 and the drive gear 168 to rotate, thereby driving the drive roller 172 to rotate. The drive roller 172 is engaged with the belts 100 of the belt assembly 98. Accordingly, rotation of the drive roller 172 drives the belts 100 to rotate. As such, the belt driving gear 124 drives the belts 100 of the belt assembly 98 to rotate.

As previously discussed, the belt assembly 98 is movable from the illustrated retracted position to the extended position. Due to the spacing between the idler gear 170 and the drive gear 168 along the longitudinal axis 74, the secondary belt driving gear 164 remains engaged with the belt driving chain 166 throughout the range of motion of the belt assembly 98 between the retracted and extended positions. With the belt assembly 98 in the illustrated retracted position, the idler gear 170 is positioned closer to the secondary belt driving gear 164, and with the belt assembly in the extended position, the idler gear 170 is positioned farther from the secondary belt driving gear 164. Because the secondary belt driving gear 164 remains engaged with the belt driving chain 166 throughout the range of motion of the belt assembly 98, the roller drive motor may drive the belts 100 to rotate while the belt assembly 98 is in the retracted position, in the extended position, and in any position between the extended and retracted positions (e.g., via the roller drive chain, the belt driving gear 124, the secondary belt driving gear 164, the belt driving chain 166, the drive gear 168, and the drive roller 172). The rotational speed of the belts 100 relative to the rotational speed of the roller drive chain may be selected by selecting a gear ratio between the belt drive gear 124 and the secondary belt drive gear 164.

In certain embodiments, the bale wrap feeding assembly includes a control panel positioned proximate to the frame and configured to enable an operator located proximate to the frame to access the control panel. The control panel includes controls configured to enable the operator to control each motor and actuator of the bale wrap feeding assembly. For example, the control panel may enable the operator to control the belt assembly actuator to move the belt assembly from the extended position to the retracted position. Furthermore, the control panel may enable the operator to control the frame drive motor to move the frame from the feeding position to the loading position. In addition, the control panel may enable the operator to control the movable feed roller actuators to drive the movable feed roller from the engaged position to the disengaged position. The control panel may also enable the operator to control the roller drive motor to drive the support rollers to rotate, thereby driving the active bale wrap to rotate, such that the end of the bale wrap of the active bale wrap assembly is positioned at the target location. The operator may then load the bale wrap between the movable feed roller and the fixed feed roller, and between the fixed feed roller and the belts, as discussed above. After the bale wrap is loaded between the fixed feed roller and the movable feed roller, the control panel may enable the operator to control the movable feed roller actuators to move the movable feed roller from the disengaged position to the engaged position. Furthermore, the control panel may enable the operator to control the frame drive motor to move the frame from the loading position to the feeding position, and the control panel may enable the operator to control the belt assembly actuator to move the belt assembly from the retracted position to the extended position. In addition, the control panel may enable the operator to control the roller drive motor to drive the rollers and the belts to drive the bale wrap toward the bale.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A bale wrap feeding assembly for an agricultural harvester, comprising:
a frame configured to move with respect to a lateral axis of the agricultural harvester from a feeding position to a loading position;
a fixed feed roller rotatably and non-movably coupled to the frame;
a movable feed roller rotatably and movably coupled to the frame, wherein the movable feed roller is movable between an engaged position and a disengaged position relative to the fixed feed roller, the movable feed roller is configured to be positioned proximate to the fixed feed roller while in the engaged position to facilitate feeding a bale wrap between the movable feed roller and the fixed feed roller, and the movable feed roller is configured to be positioned remote from the fixed feed roller while in the disengaged position to facilitate loading the bale wrap between the movable feed roller and the fixed feed roller;
a fixed feed roller gear non-rotatably coupled to the fixed feed roller; and
a movable feed roller gear non-rotatably coupled to the movable feed roller, wherein the movable feed roller gear is configured to engage the fixed feed roller gear while the movable feed roller is in the engaged position to enable rotation of the fixed feed roller to drive rotation of the movable feed roller.

2. The bale wrap feeding assembly of claim 1, comprising an actuator configured to drive the movable feed roller to move between the engaged position and the disengaged position.

3. The bale wrap feeding assembly of claim 2, comprising an arm coupled to the movable feed roller, wherein the actuator is coupled to the arm and configured to drive the arm to rotate to move the movable feed roller between the engaged position and the disengaged position.

4. The bale wrap feeding assembly of claim 1, comprising a motor configured to drive the fixed feed roller to rotate.

5. The bale wrap feeding assembly of claim 1, comprising:
a first support roller rotatably and non-movably coupled to the frame; and
a second support roller rotatably and non-movably coupled to the frame;
wherein the first support roller and the second support roller are configured to support a bale wrap assembly having the bale wrap.

6. The bale wrap feeding assembly of claim 1, comprising a motor configured to drive the frame to move between the feeding position and the loading position.

7. The bale wrap feeding assembly of claim 1, comprising a belt assembly configured to receive the bale wrap from the fixed feed roller and the movable feed roller, wherein the belt assembly is configured to drive the bale wrap to move toward a bale.

8. An agricultural harvester, comprising:
a bale wrap assembly storage compartment configured to store a plurality of bale wrap assemblies; and
a bale wrap feeding assembly configured to receive an active bale wrap assembly of the plurality of bale wrap assemblies from the bale wrap assembly storage compartment and to feed a bale wrap of the active bale wrap assembly toward a bale, wherein the bale wrap feeding assembly, comprises:
a frame configured to move with respect to a lateral axis of the agricultural harvester from a feeding position to a loading position, wherein the bale wrap feeding assembly is configured to receive the active bale wrap assembly while the frame is in the feeding position;
a fixed feed roller rotatably and non-movably coupled to the frame;
a movable feed roller rotatably and movably coupled to the frame, wherein the movable feed roller is movable between an engaged position and a disengaged position relative to the fixed feed roller, the movable feed roller is configured to be positioned proximate to the fixed feed roller while in the engaged position to facilitate feeding the bale wrap of the active bale wrap assembly between the movable feed roller and the fixed feed roller, and the movable feed roller is configured to be positioned remote from the fixed feed roller while in the disengaged position to facilitate loading the bale wrap of the active bale wrap assembly between the movable feed roller and the fixed feed roller;
a fixed feed roller gear non-rotatably coupled to the fixed feed roller; and
a movable feed roller gear non-rotatably coupled to the movable feed roller, wherein the movable feed roller gear is configured to engage the fixed feed roller gear while the movable feed roller is in the engaged position to enable rotation of the fixed feed roller to drive rotation of the movable feed roller.

9. The agricultural harvester of claim 8, wherein the bale wrap feeding assembly comprises an actuator configured to drive the movable feed roller to move between the engaged position and the disengaged position.

10. The agricultural harvester of claim 9, wherein the bale wrap feeding assembly comprises an arm coupled to the movable feed roller, and the actuator is coupled to the arm and configured to drive the arm to rotate to move the movable feed roller between the engaged position and the disengaged position.

11. The agricultural harvester of claim 8, wherein the bale wrap feeding assembly comprises a motor configured to drive the fixed feed roller to rotate.

12. The agricultural harvester of claim 8, wherein the bale wrap feeding assembly comprises:
a first support roller rotatably and non-movably coupled to the frame; and
a second support roller rotatably and non-movably coupled to the frame;
wherein the first support roller and the second support roller are configured to support the active bale wrap assembly.

13. The agricultural harvester of claim 8, wherein the bale wrap feeding assembly comprises a motor configured to drive the frame to move between the feeding position and the loading position.

14. The agricultural harvester of claim 8, wherein the bale wrap feeding assembly comprises a belt assembly configured to receive the bale wrap of the active bale wrap assembly from the fixed feed roller and the movable feed roller, and the belt assembly is configured to drive the bale wrap of the active bale wrap assembly to move toward the bale.

15. A method for loading a bale wrap of a bale wrap assembly into a bale wrap feeding assembly of an agricultural harvester, comprising:
moving a frame of the bale wrap feeding assembly with respect to a lateral axis of the agricultural harvester from a feeding position to a loading position;
moving a movable feed roller from an engaged position to a disengaged position relative to a fixed feed roller, wherein the movable feed roller is rotatably and movably coupled to the frame, the fixed feed roller is rotatably and non-movably coupled to the frame, the movable feed roller is configured to be positioned proximate to the fixed feed roller while in the engaged position to facilitate feeding the bale wrap between the movable feed roller and the fixed feed roller, and the movable feed roller is configured to be positioned remote from the fixed feed roller while in the disengaged position to facilitate loading the bale wrap between the movable feed roller and the fixed feed roller;
loading the bale wrap between the movable feed roller and the fixed feed roller; and
moving the movable feed roller from the disengaged position to the engaged position, such that a movable feed roller gear non-rotatably coupled to the movable feed roller engages a fixed feed roller gear non-rotatably coupled to the fixed feed roller to enable rotation of the fixed feed roller to drive rotation of the movable feed roller.

16. The method of claim 15, comprising moving the frame from the loading position to the feeding position after moving the movable feed roller to the engage position.

17. The method of claim 15, comprising receiving the bale wrap assembly onto a first support roller and a second support roller, wherein the first support roller is rotatably and non-movably coupled to the frame, the second support roller is rotatably and non-movably coupled to the frame; and the first support roller and the second support roller are configured to support the bale wrap assembly.

18. The method of claim 17, comprising rotating the first support roller and the second support roller to drive the bale wrap assembly to rotate to position an end of the bale wrap of the bale wrap assembly at a target location.

19. The method of claim 15, wherein moving the frame from the feeding position to the loading position comprises activating a motor to drive the frame to move from the feeding position to the loading position.

20. The method of claim 15, wherein moving the movable feed roller from the engaged position to the disengaged position comprises activating an actuator to drive the movable feed roller to move from the engaged position to the disengaged position, and moving the movable feed roller from the disengaged position to the engaged position comprises activating the actuator to drive the movable feed roller to move from the disengaged position to the engaged position.
